(19) United States
(12) Patent Application Publication
(10) Pub. No.: US 2016/0192126 A1
(43) Pub. Date: Jun. 30, 2016

(54) SYSTEM AND METHOD FOR TRACKING A DEVICE

(71) Applicant: Silver Spring Networks, Inc., Redwood City, CA (US)

(72) Inventors: Aditi Dubey, Redwood City, CA (US); Kunal Shah, Redwood City, CA (US); Greg Bruins, Redwood City, CA (US); Conroy Tam, Redwood City, CA (US); Neville Campbell, Redwood City, CA (US); Peter Hunt, Redwood City, CA (US)

(21) Appl. No.: 14/588,059

(22) Filed: Dec. 31, 2014

(51) Int. Cl. H04W 4/02; H04W 24/02; H04W 64/00; H04B 1/3816

(52) U.S. Cl. CPC H04W 4/02; H04B 1/3816; H04W 24/02; H04W 64/003

(57) ABSTRACT

A method includes detecting, by a mobile network interface card (MNIC) using a radio frequency (RF) signal, network devices of a network, generating, by the MNIC, a report identifying a network device of the network devices as detected by the MNIC, and sending, by the MNIC, the report to the network device. The method further includes forwarding, by the network device using the network, the report to a backend, identifying, by the backend, a physical location of the network device, and determining, by the backend, an approximate physical location of the MNIC based on the physical location of the network device.

### BACKGROUND

Historically, tracking the physical location of many devices in real time was an impossible task. Now, with the widespread use of the Global Positioning System (GPS) and other systems, it is possible to simultaneously track the real time physical location of many different devices. However, existing solutions still carry a considerable cost burden to both tracking of a single device and tracking of hundreds or thousands of devices simultaneously. Alternative solutions that reduce the cost of tracking devices are still desired.

### SUMMARY OF INVENTION

In general, in one aspect, the invention relates to a method, comprising: detecting, by a mobile network interface card (MNIC) using a radio frequency (RF) signal, a first plurality of network devices, wherein the first plurality of network devices comprises a network; generating, by the MNIC, a first report identifying a first network device of the first plurality of network devices as detected by the MNIC; sending, by the MNIC, the first report to the first network device; forwarding, by the first network device and using the network, the first report to a backend; identifying, by the backend, a physical location of the first network device; and determining, by the backend, an approximate physical location of the MNIC based on the physical location of the first network device.

In general, in one aspect, the invention relates to a system, comprising: a first plurality of network devices comprising a network, each of the first plurality of network devices configured to: receive a first report, and forward the first report to a backend; and a mobile network interface card (MNIC) configured to: detect, using a radio frequency (RF) signal, a first network device of the first plurality of network devices, generate the first report identifying a first network device of the first plurality of network devices as detected by the MNIC, and send the first report to the first network device, wherein the backend is configured to: identify a physical location of the first network device, and determine an approximate physical location of the MNIC based on the physical location of the first network device.

In general, in one aspect, the invention relates to a non-transitory computer-readable medium (CRM) storing a plurality of instructions, the plurality of instructions comprising functionality to: detect, by a mobile network interface card (MNIC) using a radio frequency (RF) signal, a first plurality of network devices, wherein the first plurality of network devices comprises a network; generate, by the MNIC, a first report identifying a first network device of the first plurality of network devices as detected by the MNIC; send, by the MNIC, the first report to the first network device; forward, by the first network device and using the network, the first report to a backend; identify, by the backend, a physical location of the first network device; and determine, by the backend, an approximate physical location of the MNIC based on the physical location of the first network device.

Other aspects and advantages of the invention will be apparent from the following description and the appended claims.

### BRIEF DESCRIPTION OF DRAWINGS

FIG. 1 shows a schematic diagram in accordance with one or more embodiments of the invention.

FIG. 2 shows a flowchart of a method in accordance with one or more embodiments of the invention.

FIGS. 3A, 3B, and 3C show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the detailed description, reference will be made to a mobile network interface card (MNIC), which may also be called a mobile network interface controller. These terms may be used interchangeably. The MNIC is described below.

In general, embodiments of the invention provide a method and system for tracking a device. Specifically, a MNIC detects nearby network devices using a radio frequency (RF) signal and sends a report to one of the nearby network devices. The report identifies at least some of the network devices detected by the MNIC. The report is forwarded to a backend, and the backend is able to identify the physical locations of the network devices included in the report. Based on this information, and optionally additional data contained in the report or otherwise available to the backend, the backend may determine the physical location of the MNIC. The backend may be, for example, a server or other suitable computing device(s).

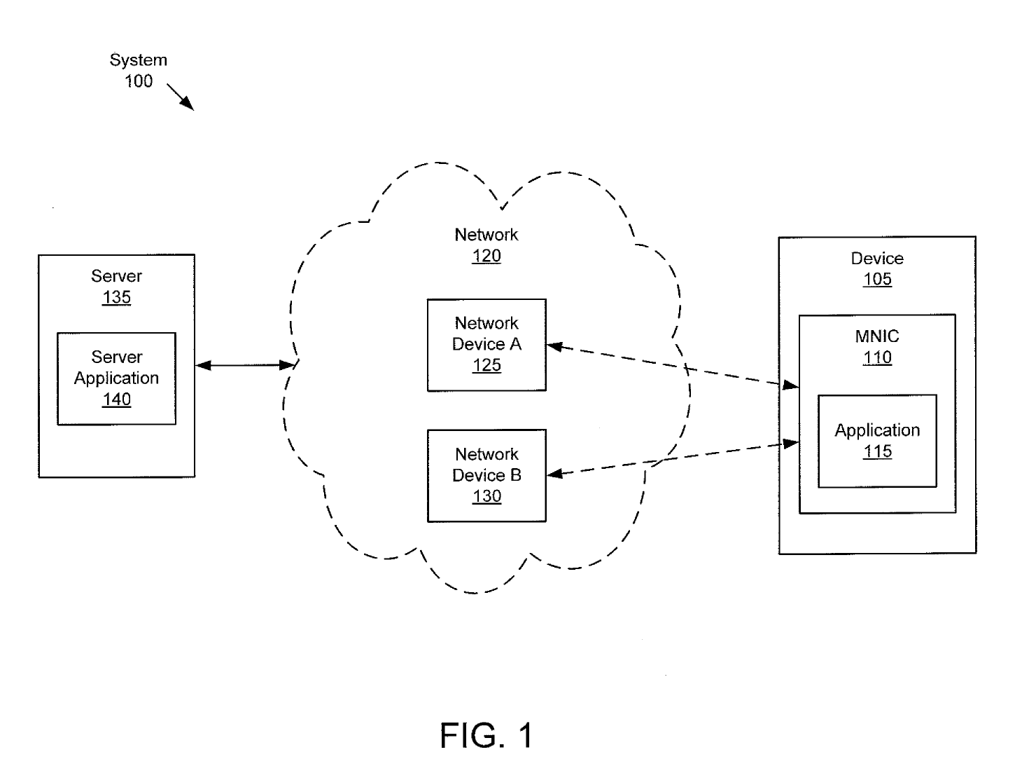

FIG. 1 shows system (100) which includes device (105) mobile network interface card (MNIC) (110), application (115), network (120), network device A (125), network device B (130), server (135), and application (140). Device (105) may be any object to which mobile network interface card (MNIC) (110) is mounted on, a part of, plugged in to, or otherwise connected. For example, device (105) may be a simple casing that allows MNIC (110) to be plugged into the auxiliary plug or universal serial bus (USB) plug of a car or truck. Alternatively, device (105) may be a self-contained device with a battery and/or any other components necessary for the operation of the invention. Further still, device may be some piece of technology such as a phone or other piece of electronics. In one or more embodiments, device (105) may include components that are not shown in FIG. 1, such as a global positioning system (GPS) component to accurately determine the location of device (105).

In one or more embodiments, mobile network interface card (MNIC) (110) is a network interface card that is mobile. MNIC (110) may include any necessary hardware components for performance of the invention including, but not limited to: memory, busses, processors, antennas, batteries, ports, etc. (not shown). Alternatively, some of the necessary hardware components may be located separately from the MNIC (110), such as on device (105). The MNIC (110) includes functionality to wirelessly communicate with other devices using radio frequency (RF) signals, such as WiFi or any other suitable standard or method. The communication range of MNIC (110) may vary depending on a variety of factors, such as the particular hardware implementation used, settings, available power, or any other suitable factor. In one or more embodiments, the communication range of MNIC (110) may be 100 feet, 1 mile, or more.

In one or more embodiments, application (115) is an application that executes on MNIC (110), device (105), or other suitable component. Alternatively, some or all of the functionality of application (115) may be implemented in the hardware of MNIC (110), rather than by software. Application (115) includes functionality to gather received signal strength indicator (RSSI) readings of nearby devices, generate reports, send reports to nearby devices, receive messages from nearby devices, and other functionalities needed by the invention.

In one or more embodiments, application (115) includes functionality for gathering RSSI readings of nearby devices. The nearby devices may be part of network (120), such as network device A (125) and/or network device B (130). In one or more embodiments, network (120) is a mesh network. A mesh network is a network in which each node relays data for the network. Alternatively, network (120) may be a network using a different topology than a mesh. In one or more embodiments, network (120) may take many different forms and have many different components. For example, network (120) may be, but is not limited to, a Wide Area Network (WAN), a Local Area Network (LAN), the Internet, cell towers or communication via cellular signals, radio signals, and/or any other network. In one or more embodiments of the invention, network (120) is a standards-based Internet Protocol Version 6 (IPv6) Network. Specifically, in one or more embodiments, network (120) may include, or may be a part of, a smart grid. A smart grid is an electrical grid that also uses information and communications technology to gather information and respond to the gathered information. The smart grid may also include other improvements on the “traditional” electrical grid. In one or more embodiments, network (120) may include, or may be part of, a street light network. A street light network is a network of smart street lights that enables a variety of functionalities, including the ability to send messages and data amongst the street lights and other components of the street light network.

In one or more embodiments of the invention, network device A (125) and/or network device B (130) are devices on a smart grid that include functionality to receive or send communications, among other functionalities. For example, network device A (125) and/or network device B (130) may include one or more of an electrical meter, a street light, an electric vehicle, an air-conditioner, a heater, a refrigerator, a transformer, a personal computer, a laptop, etc. In other words, network device A (125) and/or network device B (130) may be an endpoint on the smart grid. As another example, network device A (125) and/or network device B (130) may be a computer used by the utility company that runs, or owns, the smart grid to send commands to endpoints on the smart grid. In one or more embodiments of the invention, network device A (125) and/or network device B (130) have a Network Interface Card (NIC) (not shown) that includes functionality to handle the receiving, sending, and/or processing of communications from the smart grid. For example, network device A (125) and/or network device B (130) may be able to be remotely powered off (or on) by the electrical utility overseeing the smart grid or other party. Network device A (125) and/or network device B (130) include a unique media access control (MAC) address, which is able to uniquely identify the device. In one or more embodiments, network device A (125) and/or network device B (130) have a known, static, physical location. This physical location may be used in conjunction with other available data to determine a location of a MNIC near network device A (125) and/or network device B (130).

Further, network device A (125) and/or network device B (130) may include functionality to send or receive various requests or commands concerning topics including, but not limited to meter readings, distribution automation, outage detection, demand response, network monitoring and/or management, reports and/or other communications to or from MNIC (110), etc. Specifically, network device A (125) and/or network device B (130) include functionality to forward reports from MNIC (110) to server (135), and optionally to send data from server (135) to MNIC (110). In one or more embodiments of the invention, millions (or even tens of millions) of devices may exist on the smart grid.

Returning to application (115), an RSSI reading is a measurement of the power present in a received radio signal. Any number of different signals may be included in the RSSI reading. In one or more embodiments, an RSSI reading of any nearby network devices (i.e., network device A (125) and/or network device B (130) is gathered at a predetermined interval. The predetermined interval may be of any amount, such as once every 15 seconds, once a minute, etc. Application (115) includes functionality to optionally track multiple RSSI readings for a given network device, track of the age of the RSSI reading(s) associated with each network device, and/or when a given network device was first discovered.

In one or more embodiments, application (115) includes functionality to generate reports. The reports may be used by server (135) to determine the approximate physical location of MNIC (110). In one or more embodiments, the reports may contain any suitable information, such as RSSI readings, MAC addresses associated with the RSSI reading(s), the age of the RSSI reading(s), how long a given network device has been detected by the MNIC, etc. The reports may contain the RSSI information of any number of network devices, such as every device detectable by MNIC (110). Alternatively, the reports may be hard capped to a set number of devices, such as 5, 10, or any other number of detectable devices. In one or more embodiments, the set number of devices included in the report may be based on how many RSSI readings are necessary to determine a suitably accurate location of the MNIC (110). Optionally, the reports may include other information available to MNIC (110), such as a battery percentage, and/or any other information available to MNIC (110).

In one or more embodiments, application (115) includes functionality to send reports to nearby network devices. The reports may be used by server (135) to determine the approximate location of MNIC (110). When sending the reports, the MNIC (110) may temporarily join network (120). In one or more embodiments, a single report is sent to a single network device at predetermined intervals. The predetermined intervals may be of any amount, such as after every RSSI reading, every 10 seconds, every 45 seconds, every 2 minutes, etc. Application (115) may determine to which network device to send the report based on the RSSI reading associated with the network device(s). For example, the report may be sent to the network device with the strongest RSSI reading (in other words, the device with which the MNIC likely has the best connection). Alternatively, the report may be sent to the network device most recently discovered by the MNIC, or any other suitable method and/or standard. Ultimately, the report is destined for server (135), although MNIC (110) and application (115) do not know the specific route with which the report will take to reach server (135), due to the nature of a mesh network.

In one or more embodiments, application (115) includes functionality to receive messages and/or data from server (135), network device A (125), and/or network device B (130). The messages and/or data may be sent in any form. For example, if server (135) knows that MNIC (110) is on the way to a specific network device, then the server (135) may instruction that specific network device to send a message to MNIC (110) once that specific network device detects the presence of MNIC (110).

In one or more embodiments, server (135) is any general purpose server, cluster, rack, computer, etc. Server (135) may contain many different components including, but not limited to: a processor(s), memory, hard-drives, etc. Although depicted as separate from network (120), server (135) may be a member or component of network (120). Server is communicatively connected to network device A (125) and/or network device B (130) via network (120), and is similarly connected to MNIC (110) via network (120). In one or more embodiments, server (135) may include a data store, such as a hard drive, etc., that includes a mapping of the MAC address of network devices (i.e., network device A (125) and/or network device B (130)), to a physical location associated with the network device.

In one or more embodiments, server application (140) is an application that executes on server (135). Server application (140) includes functionality to receive reports, send messages, identify the physical location of network devices and determine an approximate location of a MNIC. Server application (140) may receive reports in any format or manner now known or later developed. Specifically, server application (140) may receive reports from MNICs that have been forwarded through a variety of nodes of a mesh network, such as network (120). In one or more embodiments, server application (140) may send messages to a MNIC. For example, a network device may be instructed by server application (140) to send an alert to a MNIC when the specified network device detects the presence of the specified MNIC.

In one or more embodiments, server application (140) includes functionality to identify the physical location of network devices. The network devices may be identified by their MAC address. The server application (140) may access a database, hard drive, or other storage location that includes a mapping of MAC addresses to physical addresses. The physical addresses may be any suitable type of address, such as a street address, GPS coordinates, etc. In one or more embodiments, server application (140) includes functionality to determine the approximate location of a MNIC, using the report generated by the MNIC. The determination may be based on any suitable factors, such as the physical location of the network devices identified in the report, the strength of the RSSI associated with the network device(s) in the report, age of the RSSI reading, the amount of time that the MNIC has been able to detect a given network device, some combination of the above factors, etc. In one or more embodiments, server application (140) includes functionality to perform triangulation, or other suitable calculations, to determine the approximate location of the MNIC.

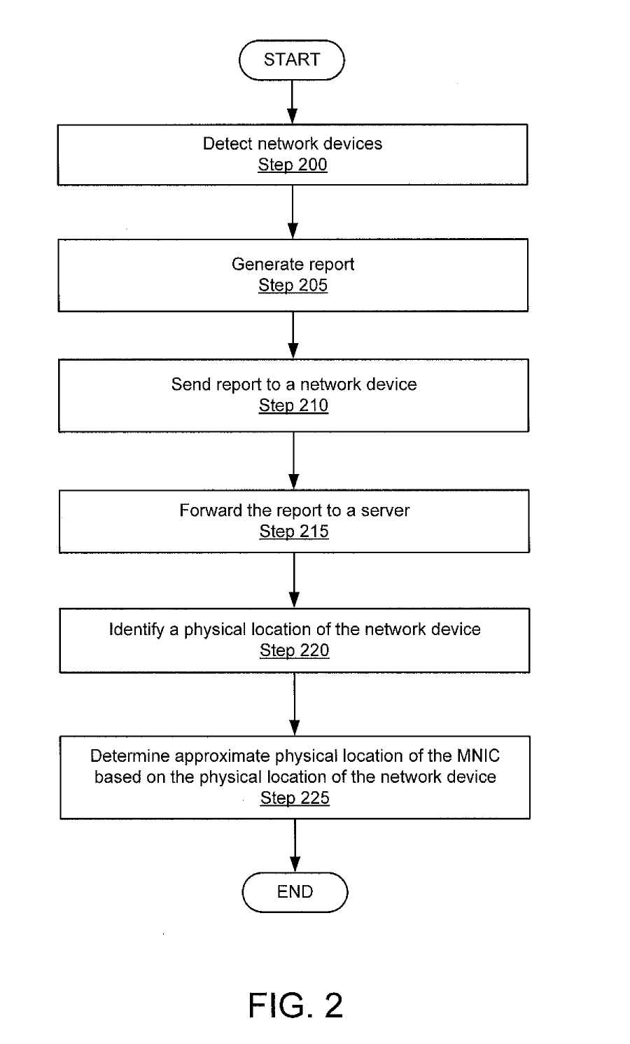

FIG. 2 shows a flowchart of a method for tracking a device, While the various steps in this flowchart are presented and described sequentially, one of ordinary skill in the art will appreciate that some or all of the steps may be executed in different orders and some or all of the steps may be executed in parallel. Further, in one or more embodiments of the invention, one or more of the steps described below may be omitted, repeated, and/or performed in a different order. Accordingly, the specific arrangement of steps shown in FIG. 2 should not be construed as limiting the scope of the invention.

In Step 200, network devices are detected, in accordance with one or more embodiments. Specifically, the network devices are detected by a MNIC. In one or more embodiments, the network devices are detected based on an RF signal, or other suitable signal. The network devices may be detected using any suitable discovery process. The MNIC may check for new devices on any suitable interval, such as every 10 seconds, every 50 seconds, every 2 minutes, or any other suitable period. The MNIC may also gather RSSI information about each detectable network device, as well as other tracking information such as the age of the reading, how long the MNIC has been able to detect a specific network device, or any other suitable information. In one or more embodiments, the MNIC identifies network devices based on their MAC address.

In Step 205, a report is generated, in accordance with one or more embodiments. The report is generated by the MNIC, and may contain any number of network devices detectable by the MNIC, such as 5, 10, or every detected network device. For each network device in the report, the report may specify: a MAC address of the network device, an RSSI reading associated with the network device, an age, and/or any other suitable information. In one or more embodiments, the age specifies the amount of time that has passed since the MNIC first discovered the associated network device. Alternatively, the age indicates how old the RSSI reading for a given network device is. In one or more embodiments, when the MNIC has detected more network devices than will be included in a report (i.e., 50 devices are detectable but 5 will be included in the report) the MNIC may determine network devices to include in the report based on age, the strongest RSSI, some other standard, or some combination of the above.

In Step 210, the report is sent to a network device, in accordance with one or more embodiments. The report may be sent in any suitable format, and may be sent on a periodic basis, such as every time new RSSI readings are taken, every minute, etc. The report is sent by the MNIC, and may be sent to the network device with the strongest RSSI. Alternatively, the MNIC may send the report to any other suitable network device, such as the most recently discovered network device. In one or more embodiments, the report is sent to a single network device per time period, as each network device is a member of a mesh network, and will be able to forward the report to a backend server. However, each time a report is sent the report may be sent to a different network device, although sometimes a subsequent report may be sent to the same network. For example, a first report may be sent to a first network device because the first network device has the strongest RSSI. However, when the second report is sent 1 minute later, the second report may be sent to a second network device that now has a stronger RSSI than the first network device. This may be due to the MNIC having moved during the 1 minute between the first and second report.

In Step 215, the report is forwarded to a server, in accordance with one or more embodiments. The report may be forwarded to the server by the network device in any manner now known or later developed. Specifically, the report may be forwarded between network devices until the report is finally able to reach the server. The report may reach the server via any number of network devices, such as 1, 100, 1000, or more.

In Step 220, a physical location of the network device is identified, in accordance with one or more embodiments. The physical location of each network device that makes up the network may be known and stored in a database, hard drive, or other suitable location. The server may identify the location of network devices in the report by using their MAC address to access a mapping that maps the MAC address to a physical address. The physical address may be a street address, a GPS location, or any other suitable identifier of a physical location where the network device is located.

In Step 220, the approximate physical location of the MNIC is determined based on the physical location of the network device(s), in accordance with one or more embodiments. In one or more embodiments, triangulation (using, for example, the RSSI of the network devices in conjunction with their physical locations) or other calculations may be performed to determine the approximate physical location of the MNIC. Alternatively, the approximate physical location of the MNIC may simply be assigned the address associated with the nearest network device, or any other suitable method.

The following section describes various examples of the invention. The examples are included to aid in the understanding of the invention and are not intended to limit the scope of the invention.

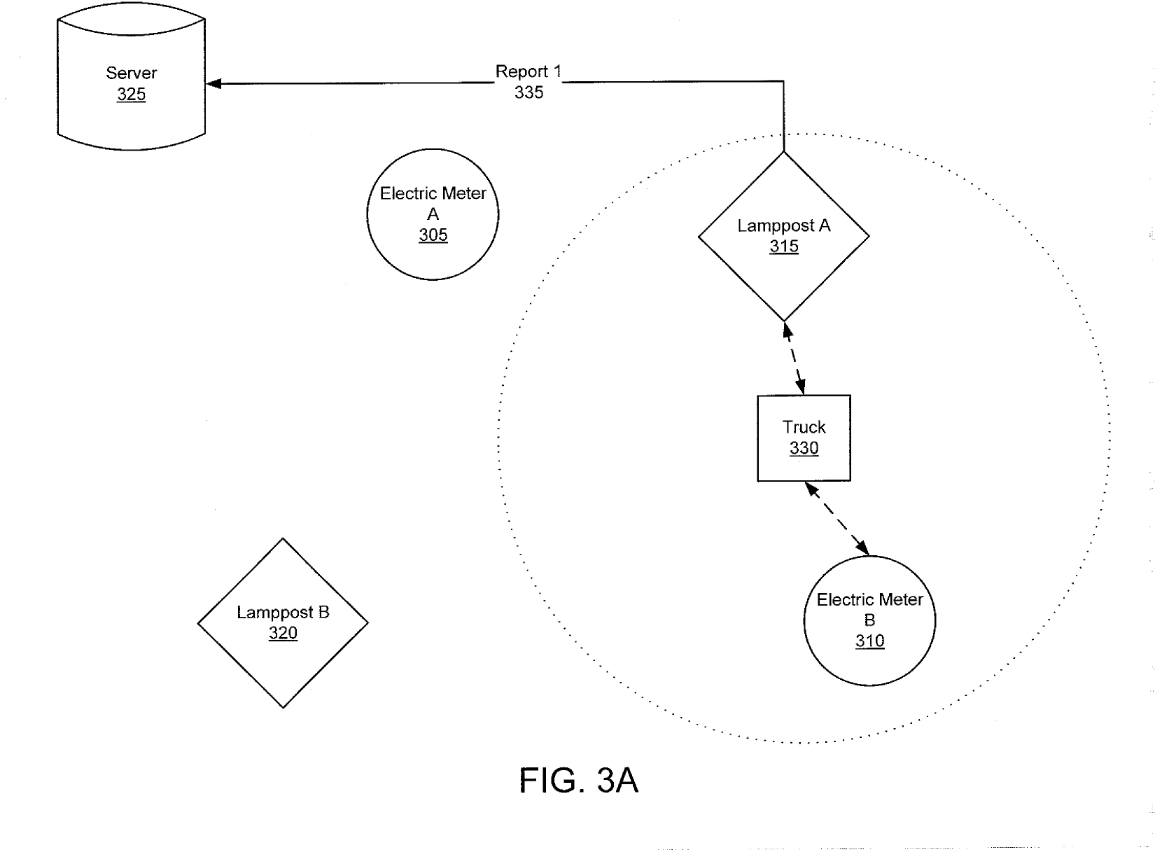

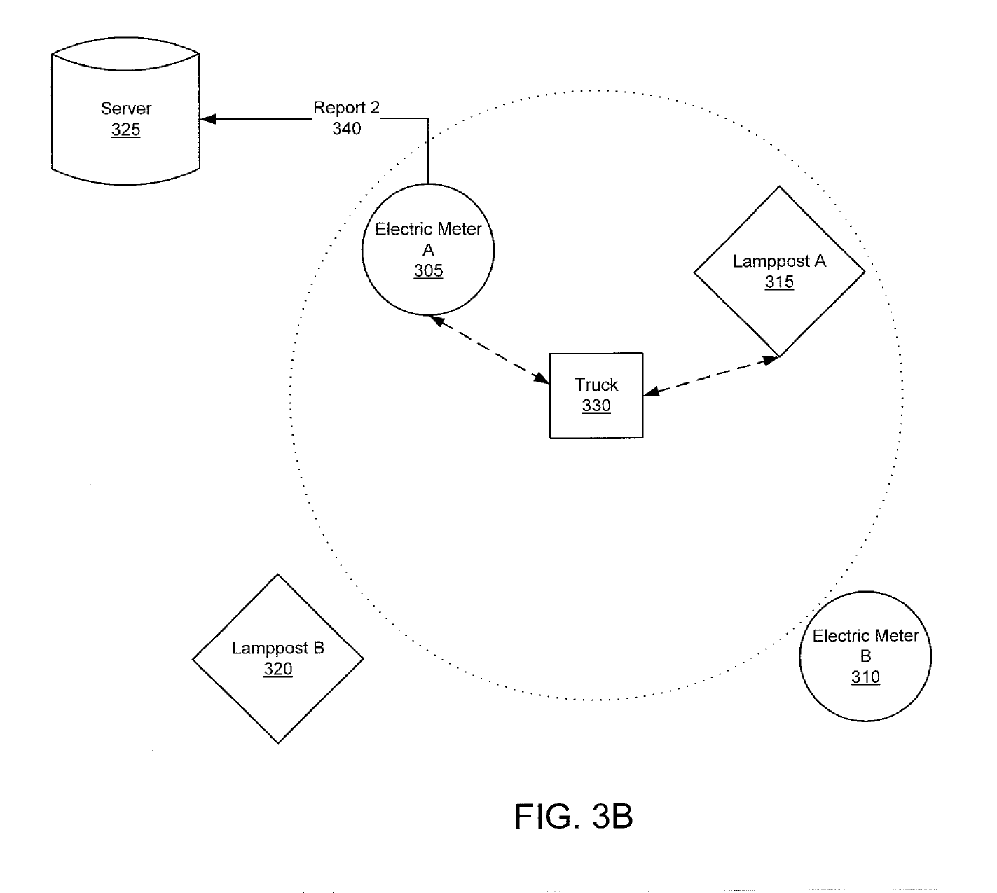

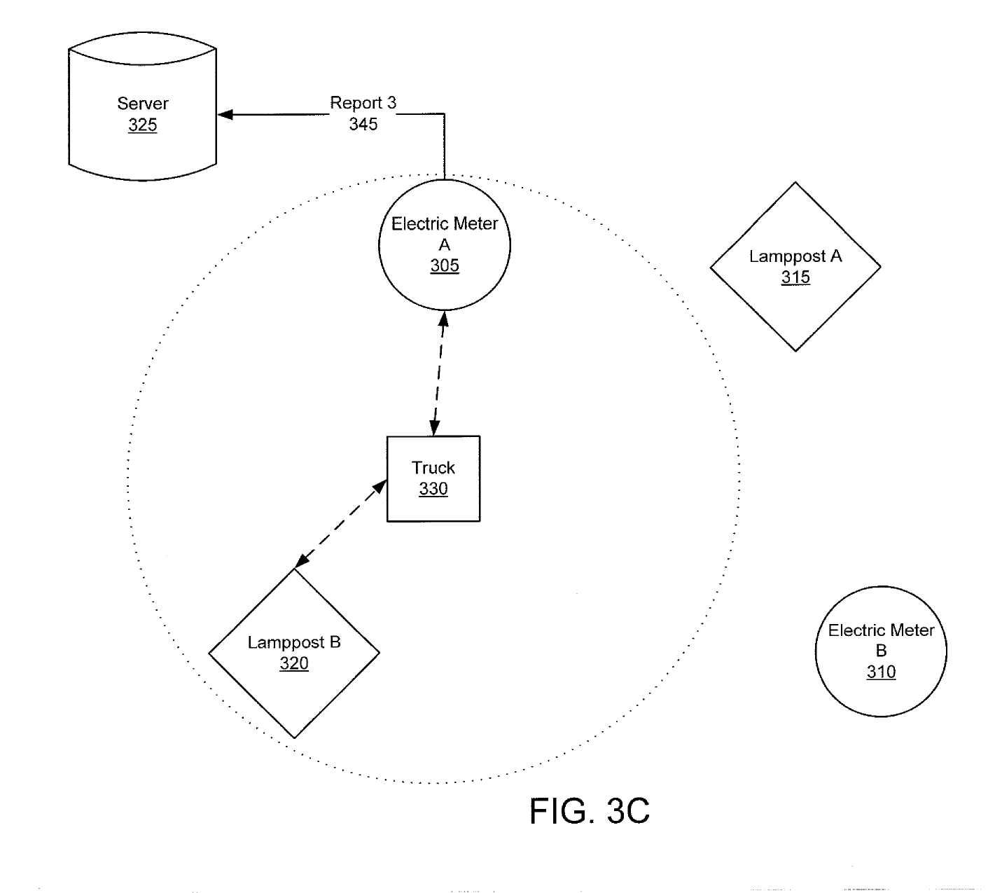

FIGS. 3A, 3B, and 3C show an example in accordance with one or more embodiments. Beginning with FIG. 3A, a truck (330) is shown moving through an area with various network devices. The network devices in this case are lamppost A (315), lamppost B (320), electric meter A (305) and electric meter B (310), which are part of a smart electric grid that forms a mesh network, and enables communication to occur between server (325) and the various nodes of the mesh network. The truck (330) includes a MNIC that automatically discovers nearby network devices and determines an RSSI reading for the discovered devices. The dotted circle around truck (330) is the effective range of the MNIC—outside of the dotted circle the MNIC is unable to discover new devices. Thus, in FIG. 3A. the MNIC of truck (330) is only able to detect lamppost A (315) and electric meter B (310).

Periodically, the MNIC of truck (330) gathers an RSSI reading of lamppost A (315) and electric meter B (310). The MNIC then generates a report with the MAC addresses of lamppost A (315) and electric meter B (310), the RSSI readings of lamppost A (315) and electric meter B (310), and an age for lamppost A (315) and electric meter B (310), and sends report 1 (335) to server (325). The MNIC does this via lamppost A (315) because lamppost A (315) has the stronger RSSI reading out of the two network devices currently detectable by the MNIC in truck (330).

Once server (325) receives report 1 (335), server (325) is able to determine a physical location for the network devices included in report 1 (335) using their MAC addresses. From the physical locations of the network devices, server (325) my determine an approximate physical location of truck (330) using, for example, triangulation or other suitable methods.

Continuing the example on FIG. 3B, truck (330) has now moved. Thus, the MNIC inside truck (330) is able to detect different devices—electric meter A (305) and lamppost A (315). Electric meter B (310) is no longer in range of truck (330). As before, the MNIC of truck (330) gathers an RSSI reading of electric meter A (305) and lamppost A (315). The MNIC then generates a report with the MAC addresses of electric meter A (305) and lamppost A (315), the RSSI readings of electric meter A (305) and lamppost A (315), and an age for electric meter A (305) and lamppost A (315), and sends report 2 (340) to server (325), The MNIC does this via electric meter A (305) because electric meter A (305) has the stronger RSSI reading out of the two network devices currently detectable by the MNIC in truck (330).

As before, once server (325) receives report 2 (335), server (325) is able to determine a physical location for the network devices included in report 2 (335) using their MAC addresses. From the physical locations of the network devices, server (325) may determine an approximate physical location of truck (330) using, for example, triangulation or other suitable methods.

Continuing the example on FIG. 3C, truck (330 has moved again. Thus, the MNIC inside truck (330) is able to detect different devices—electric meter A (305) and lamppost B (320). Lamppost A (315) is no longer in range of truck (330). As before, the MNIC of truck (330) gathers an RSSI reading of electric meter A (305) and lamppost B (320). The MNIC then generates a report with the MAC addresses of electric meter A (305) and lamppost B (320), the RSSI readings of electric meter A (305) and lamppost B (320), and an age for electric meter A (305) and lamppost B (320), and sends report 3 (345) to server (325). The MNIC does this via electric meter A (305) because electric meter A (345) has the stronger RSSI reading out of the two network devices currently detectable by the MNIC in truck (330).

As before, once server (325) receives report 2 (335), server (325) is able to determine a physical location for the network devices included in report 3 (345) using their MAC addresses. From the physical locations of the network devices, server (325) may determine an approximate physical location of truck (330) using, for example, triangulation or other suitable methods.

It will be apparent to one of ordinary skill in the art, having the, benefit of this disclosure, that the method of this invention is the opposite of the expect approach to determining a devices location. Normally, the stationary network devices would simply send reports back indicating what devices they are able to discover, and the locations of the detected devices may be determined. However, having the MNIC gather the RSSI readings and send the reports helps limit unnecessary network traffic, and gives a more accurate picture of where the MNIC is. Additionally, another benefit of this invention is the reduced cost to implement the invention and the reduction in cost associated with transmitting the data. For example, if cell data were used to transmit the report to the server, every mobile device may require a costly cell data plan. When the reports may be sent to the server using a pre-existing mesh network, the cost of transmitting the reports is virtually zero. Further, the cost of implementing a MNIC and associated hardware is far less than the hardware cost associated with other forms of communication. Thus, the present invention enables significant cost savings to be had.

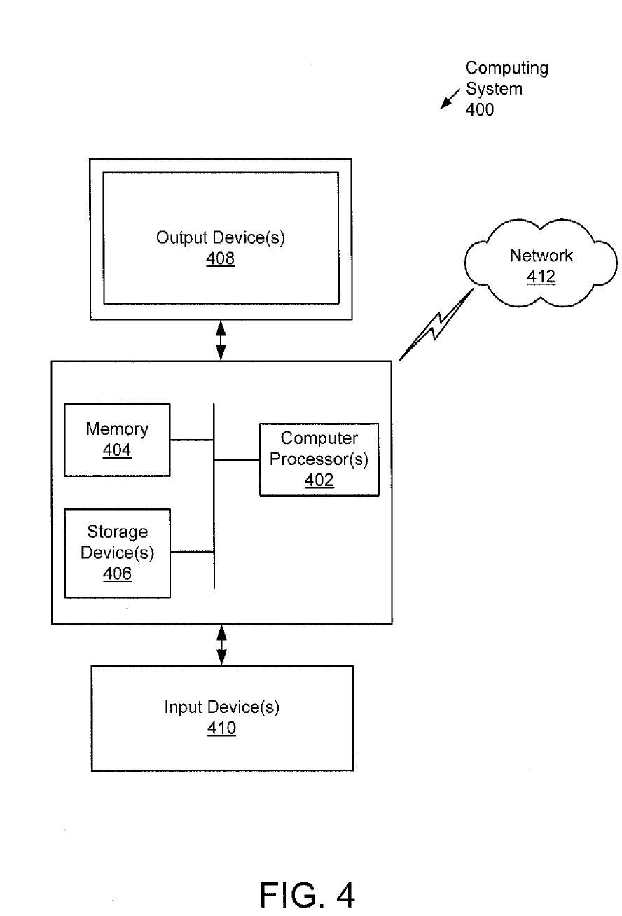

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
detecting, by a mobile network interface card (MNIC) using a radio frequency (RF) signal, a first plurality of network devices, wherein the first plurality of network devices comprises a network;
generating, by the MNIC, a first report identifying a first network device of the first plurality of network devices as detected by the MNIC;
sending, by the MNIC, the first report to the first network device;
forwarding, by the first network device and using the network, the first report to a backend;
identifying, by the backend, a physical location of the first network device; and
determining, by the backend, an approximate physical location of the MNIC based on the physical location of the first network device.

2. The method of claim 1, further comprising:
determining, by the MNIC and for each of the first plurality of network devices, a received signal strength indication (RSSI),
wherein the first report comprises: a media access control (MAC) address of the first network device, the RSSI for the first network device, and an age of the RSSI for the first network device.

3. The method of claim 2, wherein the first network device is associated with a strongest RSSI of the plurality of network devices.

4. The method of claim 2,
wherein the physical location of the first network device is static, and
wherein the MAC address of the first network device is mapped to the physical location of the first network device.

5. The method of claim 2, further comprising:
performing, by the backend, triangulation based on the first report to determine the approximate physical location of the MNIC,
wherein the first report further comprises an RSSI for each network device of a subset of the first plurality of network devices.

6. The method of claim 1, further comprising:
detecting, by the MNIC using the RF signal, a second plurality of network devices, wherein the second plurality of network devices comprises the network;
generating, by the MNIC, a second report identifying a second network device of the second plurality of network devices as detected by the MNIC;
sending, by the MNIC, the second report to the second network device;
forwarding, by the second network device and using the network, the second report to the backend;
identifying, by the backend, a physical location of the second network device; and
updating, by the backend, the approximate physical location of the MNIC based on the physical location of the second network device.

7. The method of claim 1, wherein the first report further comprises a battery percentage.

8. The method of claim 1,
wherein the backend is a server,
wherein the first network device is an electricity meter, and
wherein the network is a smart grid.

9. A system, comprising:
a first plurality of network devices comprising a network, each of the first plurality of network devices configured to:
receive a first report, and
forward the first report to a backend; and
a mobile network interface card (MNIC) configured to:
detect, using a radio frequency (RF) signal, a first network device of the first plurality of network devices,
generate the first report identifying a first network device of the first plurality of network devices as detected by the MNIC, and
send the first report to the first network device,
wherein the backend is configured to:
identify a physical location of the first network device, and
determine an approximate physical location of the MNIC based on the physical location of the first network device.

10. The system of claim 9, further comprising:
determining, by the MNIC and for each of the first plurality of network devices, a received signal strength indication (RSSI),
wherein the first report comprises: a media access control (MAC) address of the first network device, the RSSI for the first network device, and an age of the RSSI for the first network device.

11. The system of claim 10, wherein the first network device is associated with a strongest RSSI of the plurality of network devices.

12. The system of claim 10,
wherein the physical location of the first network device is static, and
wherein the MAC address of the first network device is mapped to the physical location of the first network device.

13. The system of claim 10, wherein the backend is further configured to:
perform triangulation based on the first report to determine the approximate physical location of the MNIC,
wherein the first report further comprises an RSSI for each network device of a subset of the first plurality of network devices.

14. The system of claim 9, further comprising:
a second plurality of network devices comprising the network, each of the second plurality of network devices configured to:
receive a second report, and
forward, using the network, the second report to the backend,
wherein the MNIC is further configured to:
detect, using the RF signal, the second plurality of network devices,
generate the second report identifying a second network device of the second plurality of network devices as detected by the MNIC, and
send the second report to the second network device, and
wherein the backend is further configured to:
identify a physical location of the second network device, and
update the approximate physical location of the MNIC based on the physical location of the second network device.

15. The system of claim 9, wherein the first report further comprises a battery percentage.

16. The system of claim 9,
wherein the backend is a server
wherein the first network device is an electricity meter, and
wherein the network is a smart grid.

17. A non-transitory computer-readable medium (CRM) storing a plurality of instructions, the plurality of instructions comprising functionality to:
detect, by a mobile network interface card (MNIC) using a radio frequency (RF) signal, a first plurality of network devices, wherein the first plurality of network devices comprises a network;
generate, by the MNIC, a first report identifying a first network device of the first plurality of network devices as detected by the MNIC;
send, by the MNIC, the first report to the first network device;
forward, by the first network device and using the network, the first report to a backend;
identify, by the backend, a physical location of the first network device; and
determine, by the backend, an approximate physical location of the MNIC based on the physical location of the first network device.

18. The non-transitory CRM of claim 17, further comprising functionality to:
determine, by the MNIC and for each of the first plurality of network devices, a received signal strength indication (RSSI),
wherein the first report comprises: a media access control (MAC) address of the first network device, the RSSI for the first network device, and an age of the RSSI for the first network device.

19. The non-transitory CRM of claim 18, wherein the first network device is associated with a strongest RSSI of the plurality of network devices.

20. The non-transitory CRM of claim 18,
wherein the physical location of the first network device is static, and
wherein the MAC address of the first network device is mapped to the physical location of the first network device.
